(19) United States
(12) Patent Application Publication
(10) Pub. No.: US 2012/0188331 A1
(43) Pub. Date: Jul. 26, 2012

(54) CONTENT DISTRIBUTION SYSTEM

(75) Inventors: Duncan Barclay, London (GB); James Ohene-Djan, London (GB)

(73) Assignee: CORRESPONDENT CORP. LTD., London (GB)

(21) Appl. No.: 13/388,958

(22) PCT Filed: Aug. 4, 2010
(86) PCT No.: PCT/GB2010/051291

§ 371 Date: Apr. 11, 2012

(30) Foreign Application Priority Data
Aug. 5, 2009 (GB) 0913646.6

(51) Int. Cl. H04N 7/15; G06F 15/16

(52) U.S. Cl. 348/14.08; 709/219; 348/E07.083

(57) ABSTRACT

A content server for managing a video conference session between two or more users, each user being located at a remotely located user terminal, the server comprising: input means arranged to receive streaming video from a user terminal; file streaming means arranged to stream video to each user terminal wherein the content server is arranged to receive video from one user terminal at a time and to stream the received video to the other user terminals.

### FIELD OF THE INVENTION

The present invention relates to a content distribution system. In particular, the present invention relates to the field of video message exchange and video conferencing across computer and communication networks.

### BACKGROUND TO THE INVENTION

Traditional communication mechanisms include telephone based communications and email based communications. Although these communication mechanisms have their own various strengths they do have drawbacks. Telephone conferencing for example is well known and allows individuals to engage easily in direct conversation but requires all parties to be present at the same time. Email communications allow the easy exchange of messages between parties and do not require parties to be online at the same time. However, email communications can become impersonal and contextual information can often be lost.

Video hosting websites such as www.youtube.com allow users to post and view videos over the Internet. However, such sites do not support the direct exchange of video messaging between users.

Known video conferencing systems generally require expensive equipment and software to be set up at either end of a proposed communications link and so are generally only used sparingly. Such systems can also often require a high speed broadband internet connection in order to operate correctly.

It is therefore an object of the present invention to provide a content distribution system that overcomes or substantially mitigates the limitations of the prior art.

### STATEMENTS OF INVENTION

According to a first aspect the present invention provides a content server for managing a video conference session between two or more users, each user being located at a remotely located user terminal, the server comprising: input means arranged to receive streaming video from a user terminal; file streaming means arranged to stream video to each user terminal wherein the content server is arranged to receive video from one user terminal at a time and to stream the received video to the other user terminals.

Conveniently, the content server may further comprise processing means arranged to manage a conference session between the two or more users. Conveniently, the processing means may be arranged to designate one user at any given time as a transmitting user, the transmitting user being capable of streaming video to the content server. The processing means may also be arranged to designate the other users, at the any given time, as receiving users.

Conveniently, the processing means may comprise selection means arranged to allow a user to request transmitting user status. The selection means may also comprise a token arrangement, transmitting user status being conferred on the user who has the token at any given time.

Preferably, the processing means may comprise notification means arranged to notify all users in the video conference who is designated as transmitting user.

The content server may also further comprise a data store arranged to store the received video. The data store may be arranged to store video contributions from each user [as they are designated transmitting user]. The video contributions from each user in the video conference session may be stored together as a single video file. Further, the stored video file may be stored as part of a video package, the video package additionally comprising a meta-data file.

Conveniently, the content server further comprises a data store for storing a plurality of content files and the file streaming means is arranged to stream one or more of the stored content files to a user terminal on request. Conveniently, each time a content file is streamed to a user terminal the content server is additionally arranged to stream a third party content file, the third party content file being selected in dependence upon attribute information associated with the third party content file and a user profile associated with the user terminal to which the content file is being streamed.

According to a second aspect the present invention provides a content server for distributing content to a first communications apparatus, the server comprising: a data store for storing a plurality of content files; file streaming means arranged to stream one or more content files to the first communications apparatus wherein the data store is arranged to store each content file as part of a content package, the content package comprising the content file and a meta-data file relating to the content file.

The server may be arranged to update the meta-data file each time the particular content file is streamed. Conveniently, the server may be arranged to update the meta-data file with details of the number of times the particular content file has been streamed.

Preferably, each communications apparatus may be associated with a user and the server may be arranged to update the meta-data file with details of the user who has requested the content file.

Conveniently, the server is arranged to stream content files to a plurality of communications devices, each communications device being associated with a user profile, each user profile comprising user-related content preferences.

Conveniently, the data store may comprise content packages that have originated from a third party [communications apparatus], the meta-data file of each third party content package comprising attribute information associated with the corresponding content file within the third party content package. In such a case, when the content file is streamed to the first communications apparatus, the server may be arranged to additionally stream a third party content file, the third party content file being selected in dependence upon the attribute information associated with the third party content files and the user profile associated with the second communication apparatus. Conveniently, the third party content file may be appended to the content file.

Preferably, the content server may be arranged to distribute content files between a plurality of communications apparatus and wherein, each time a content file is streamed to a communications apparatus, an associated meta-data file may be updated. Conveniently, each time a content file is streamed to a communications apparatus the content server may be arranged to additionally stream a third party content file, the third party content file being selected in dependence upon attribute information associated with the third party content file and user profiles associated with the plurality of communications apparatus.

Preferably, the server further comprises input means arranged to receive content files uploaded from a first communications apparatus for subsequent streaming to other communications apparatus

According to a third aspect the present invention provides a content server for distributing content to a communications apparatus, the server comprising: a data store for storing content packages, each content package comprising one or more content files and a meta-data file, the meta-data file comprising attribute information associated with the one or more content files; file streaming means arranged to stream user-selected content files to the communications apparatus wherein the communications apparatus is associated with a user profile, the user profile comprising user related content preferences and wherein, when a content file is selected and streamed to the communications apparatus, an additional content file is selected in dependence on the attribute information associated with the content files and the user profile associated with the communication apparatus, the additional content file being streamed to the communications apparatus in addition to the selected content file.

The additional content file may be appended to the file stream after the user selected content file (in alternative arrangements the additional content file may precede the selected file stream or may be streamed simultaneously, e.g. in the case of video streaming the additional content file could appear as a banner or on a different part of a display screen). In one example, the additional content file may be loaded onto the content server by a broadcaster. Preferably the content files comprise video files.

Conveniently, the additional content may be an advert.

The invention extends to a content server according to the second or third aspects of the present invention in which the communications apparatus is a networked computer or an internet enabled mobile communications device. The invention also extends to a content server according to the first aspect of the invention in which the user terminal is a networked computer or an internet enabled mobile communications device.

The invention extends to a method of operating a content server to provide the functionality of the content server according to the first to third aspects of the present invention. The invention also extends to a computer program to operate a content server to provide the functionality of the content server according to the first to third aspects of the present invention.

According to a fourth aspect the present invention provides a content file comprising a two or more content portions and a meta-data file, the two or more content portions relating to content received from different sources. Preferably, the content portions are received from different communications devices belonging to different users of a content distribution system.

The fourth aspect of the present invention may preferably relate to the single video file created, for example, during a video conference according to the first aspect of the present invention.

The invention extends to a content distribution system comprising a content server according to any of the first, second or third aspects of the present invention and a plurality of communications devices/apparatus/user terminals.

### BRIEF DESCRIPTION OF THE DRAWINGS

The present invention is described, by way of example only, with reference to the following figures, in which:

FIG. 1 is a schematic representation of the architecture of the present invention;

FIG. 2 illustrates the various video based applications that may be accessed via the graphical user interface in accordance with embodiments of the present invention;

FIG. 3 illustrates the component parts of a video package in accordance with embodiments of the present invention;

FIGS. 4a and 4b illustrate a video conferencing feature in accordance with embodiments of the present invention;

FIG. 5 shows an example of the output of a video conference in accordance with embodiments of the present invention;

FIG. 6 shows a more detailed view of the server computer and data store of FIG. 1;

FIG. 7 shows the process of updating meta-data in accordance with embodiments of the present invention;

FIG. 8 shows the process of appending additional video content to a requested video file in accordance with embodiments of the present invention.

### DETAILED DESCRIPTION OF THE INVENTION

The following description describes embodiments of the present invention in which the content files stored and distributed by the content server are video files. It is appreciated however that the invention may apply to other types of content file, e.g. audio files etc.

Referring to FIG. 1, a schematic of a system 100 architecture in accordance with an embodiment of the present invention is shown.

It is noted that the system comprises a central server 1 which is in communication, via a suitable communications network, with a number of users (102, 104, 106, 108). The server 1 further comprises a session manager 3 for controlling communications across the communications network and is also connected to a data store 5 which holds video files that can be viewed by the users 102, 104, 106, 108. It is also noted that the video files within the data store may be uploaded to the server by the users.

Each user may send and receive information to/from the server 1. When user 104 sends a video file 7 to user 102 the file 7 is in fact uploaded to the server and then streamed to user 102. In effect, however, it appears that user 104 has sent the file directly to user 102 (indicated by broken line 9).

A broadcaster 110 is also shown in the figure. The broadcaster 110 may send one way video traffic 13 to subscribed users, e.g. user 102. Again, although user 102 apparently receives broadcast video direct from the broadcaster 110 it is noted that such content is in fact sent to the server 1 and stored in the data store 5 before being streamed to the user.

It is further noted that users 102 to 108 are all registered users of the system.

Communications between users can only occur once a user has invited another into their list of friends. As such the communications system 100 in accordance with embodiments of the present invention operates on a “white list” principle. It is noted that this arrangement enables a number of prior art problems to be addressed and is in contrast to other communications arrangements (such as YouTube) in which each user is visible to all other users and any given user may contact another user.

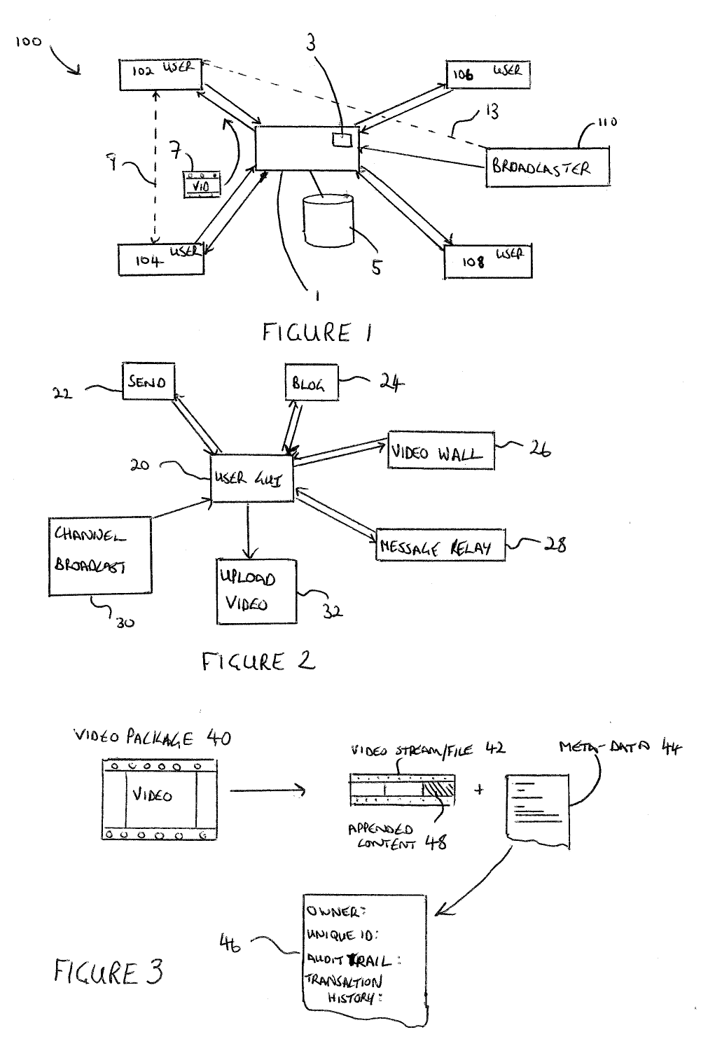

FIG. 2 is a representation of the various forms of video communication that each user may send/receive via a graphical user interface 20 on their computer or other communications device (e.g. an enabled mobile telephone, personal media player, laptop, PDA etc.).

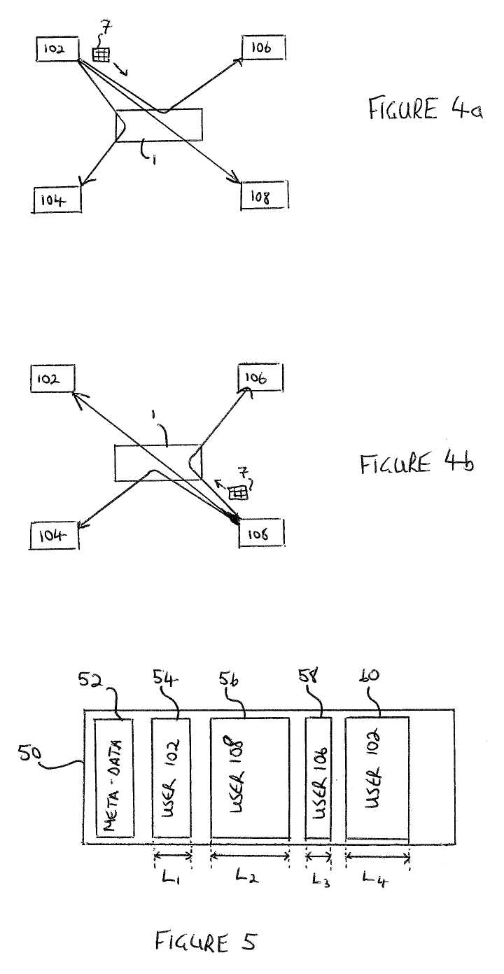

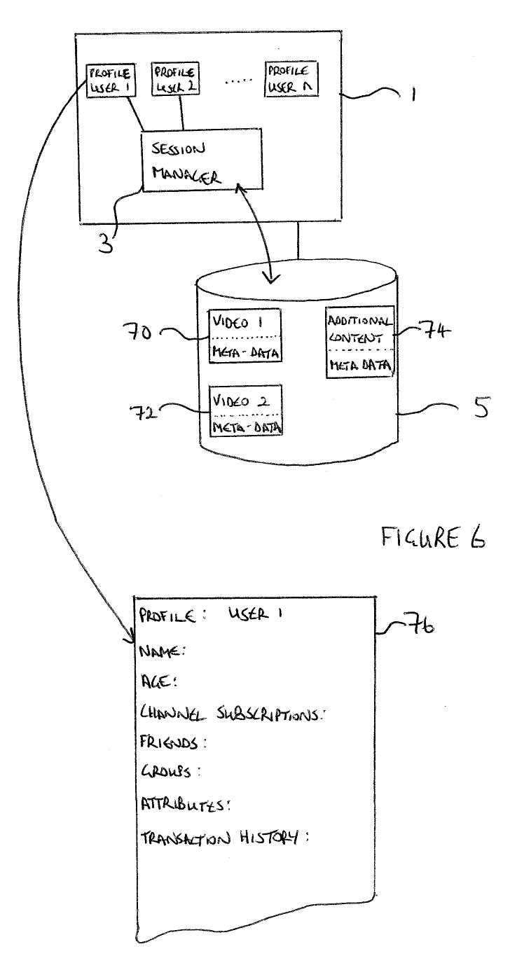

Each user may send/receive messages 22, post videos to a video blog 24, view blog videos, post messages to a communal video wall 26 (e.g. the server may host an area dedicated to a particular subject, e.g. a particular sporting event, and users may post videos to the hosted area) and also take part in two-way or multi-way video conferencing 28 (described further in relation to FIG. 4).

Users may also receive videos sent from a channel broadcaster 30 (e.g. a user may subscribe to receive video updates from, for example, BBC Sport coverage). A video upload facility 32 also enables users to upload their own content (either recorded themselves or taken from another source) to the server.

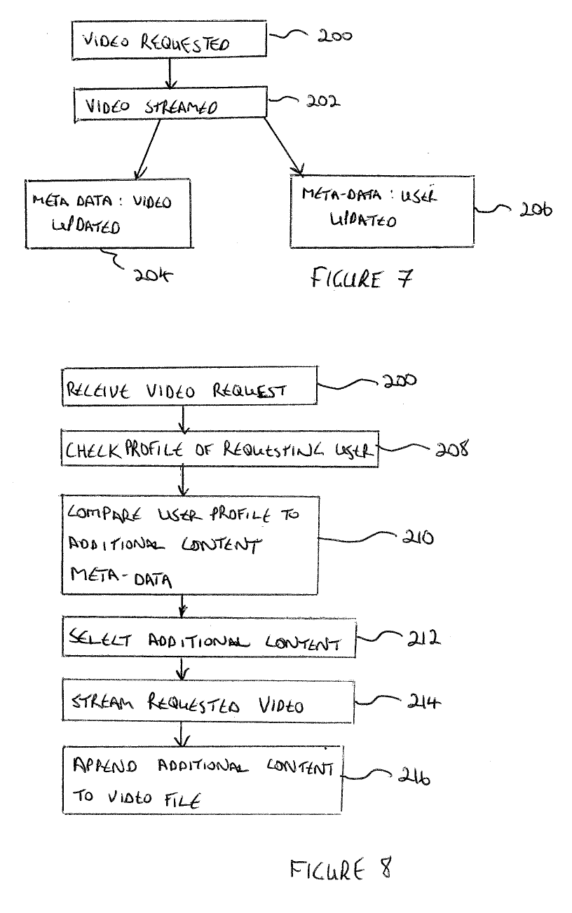

As shown in FIG. 3, video files stored on the system are in the form of a video package 40 that comprises the video file 42 stored on the server and an associated meta-data file 44. The meta-data may include information 46 such as: the owner/originator of the video file; a unique identifier for the video file; title of the file; description of the file; an audit trail that details which users have viewed/requested the content and when; a transaction history that details how many times a video may have been accessed by users. The description of the video file that is stored in the meta-data file may also comprise information that classifies the type of video file (e.g. sport, film, music) and also the sub-type of the video (e.g. tennis for the sport classification; comedy for the film classification, blues for the music classification etc.). The video file may be therefore be classified according to any suitable taxonomy which would then allow content to be matched to users on the basis of a profile (see FIGS. 6 to 8).

It is noted that the presence of an updatable meta-data file associated with the video file is enabled by virtue of the fact that all files are stored on the central server and it is the central server that coordinates communications by users. Essentially the central server may be configured to update the meta-data associated with a given video file each time that file is accessed in any way.

Content that is requested by or delivered to a user is sent in the form of a video stream. As shown in FIG. 3 this video stream comprises the content of the video file 42 stored on the central server plus, optionally, additional appended content 48, e.g. an advert or other content that may be associated with either the requested/delivered video file or the user. The selection of the optional appended content 48 is described in more detail below in relation to FIGS. 6 to 8.

FIGS. 4a and 4b show how a multi-way videoconference may be supported by the system according to an embodiment of the present invention. Initially, user 102 is speaking and transmits, via the central server, video to the other three users in the conference. Once user 102 has finished speaking, user 108 takes over and transmits video to the other three users.

It is noted that this arrangement does not require simultaneous uplink and downlink connections to all four users (102, 104, 106, 108). Therefore, instead of needing to support eight separate data streams the system only needs to provide four data streams at any one time (one uplink from the active user and three downlinks to the other users).

The identity of the active user is indicated by an icon which may be displayed on each users' GUI. Selection of the active user may be predetermined or may be on the basis of a selection button (either physical or via the GUI) which registers a user's desire to become the active user.

It is noted that whilst any given user is the active user all the remaining users will be receiving a video stream from that user (see for example FIG. 4a where user 102 is streaming video 7). When the active user moves to another user in the conference then the new active user will transmit to all the other remaining users (see FIG. 4b where user 108 is now streaming video to the other users).

In line with the system as described above, the video from the transmitting user is uploaded to the server where it is streamed to the other users.

Since the central server 1 manages communications between users 102 to 108 it is able to record each video contribution from the users into a single video file 50—see FIG. 5. This file comprises a single meta-data section 52 which can detail the various participants in the conversation as well as where their individual contributions may be found within the complete file. Since only one user at a time is transmitting video the recorded file is comprised of a series of slices (54, 56, 58, 60) each of which relates to a different user (102, 108, 106, 102 respectively). As shown in FIG. 5 the various slices are of differing lengths (L₁-L₄) indicating that the individual contributions are of varying length.

FIG. 6 shows a more detailed view of the server computer 1 and data store 5 of FIG. 1. It can now be seen that the data store 5 comprises three different video packages (70, 72, 74) corresponding to video files 1 and 2 and also an additional content file. Each of the video files within the three video packages shown in FIG. 6 is associated with a meta-data file similar to that described above in relation to FIG. 3.

It is noted that the additional content file 74 may be a video file that would be accessed in its own right or it may be a content file that relates to another video file stored in the data store (for example, video file 1 may be a movie trailer and the additional content file may be a “behind the scenes” film clip relating to that movie trailer). Alternatively, the additional content file may be unrelated to any other video file within the data store, e.g. it could be an advert.

The session manager 3 is arranged to supply requested video files to users and may also append additional content to any video streamed to a user on the basis of a stored user profile 76 relating to the user requesting the video content. An example of a user profile is shown in FIG. 6 and it can be seen that the profile contains information that identifies the user (name, age, friends etc.) and information that relates to their preferences (e.g. groups that they are a member of, attributes, for example, the type of music/films they like, and their transaction history which could be a list of all video files that they have requested and all video files they have completely viewed along with a play count to record whether they have requested particular videos repeatedly).

It can be seen therefore that the user profile comprises a mixture of static information (name, age etc.) and information that may be updated over time (preference information). The user profile can therefore be regarded as comprising meta-data relating to the user.

FIG. 7 shows the process of updating meta-data.

In Step 200, a user requests a video file from the server computer (Note: the term “request” in this context covers an explicit request from a user for a video file stored on the server computer. However, the term also covers the opening of a video message in a message inbox. Since all video files are stored on the central server then actual video files are not delivered to a user. Rather a link to the video file is delivered and the action of opening a video message triggers the server computer to stream the content to the user, in effect therefore the user has “requested” the video file).

In Step 202 the server computer streams the video to the user. In Step 204 the meta-data file associated with the video file is updated by the server computer with details of the user that requested the video and date/time code information. In Step 206, the user profile of the user who requested the video is updated with details of the requested video (e.g. the transaction history field of the user profile is updated).

It is noted that depending on the system set up Steps 204 and 206 may be carried out simultaneously or in any preferred order.

FIG. 8 shows the process of appending additional video content to a requested video file. In Step 200, the user requests a video file from the server and this request is received by the server computer.

In Step 208, the server computer checks the profile of the user who has requested the video file.

In Step 210, the server computer compares the user profile to the meta-data files associated with additional content stored in the data store.

In Step 212, additional content is selected on the basis of the comparison in Step 210.

In Step 214, the requested video file is streamed from the server computer to the user and in Step 216, the selected additional content is appended to the end of the video stream.

The meta-data used from the user profile to select the additional content may be defined by means of a questionnaire that the user completes during a registration procedure or alternatively may be compiled by the server computer via an analysis of the videos they have viewed and/or the channels/groups they have registered for.

It is noted that the use of a central server allows the viewing habits of registered users to be tracked. Use of meta-data files associated with the stored video files allows popular video files to be tracked and the use of user profile information allows additional content to be specifically targeted to users who will be most likely to view and appreciate it.

In this manner it is noted that the present invention provides a mechanism for increasing the effectiveness of, for example, advertising. Since adverts can be matched to users via the information contained within their profiles the overall effectiveness of a given advert may be increased compared to an advertising model in which an advert is sent in a blanket manner to all users on the system.

It is noted that references to “user terminals” herein encompass computer terminals, laptops, mobile devices (such as mobile phones, tablet PCs, notepads, tablet devices etc). Similarly, “communication apparatus” or “communications device” is taken to mean computer terminals, laptops, mobile devices (such as mobile phones, tablet PCs, notepads, tablet devices etc).

It will be understood that the embodiments described above are given by way of example only and are not intended to limit the invention, the scope of which is defined in the appended claims. It will also be understood that the embodiments described may be used individually or in combination.

1. A content server for managing a video conference session between two or more users, each user being located at a remotely located user terminal, the server comprising:
inputs arranged to receive streaming video from a user terminal;
a file streaming module arranged to stream video to each user terminal wherein the content server is arranged to receive video from one user terminal at a time and to stream the received video to the other user terminals.

2. A content server as claimed in claim 1, further comprising a processor arranged to manage a conference session between the two or more users.

3. A content server as claimed in claim 2, wherein the processor is arranged to designate one user at any given time as a transmitting user, the transmitting user being capable of streaming video to the content server, and arranged to designate the other users, at the any given time, as receiving users and wherein the processor comprises a selection module arranged to allow a user to request transmitting user status, the selection module comprising a token arrangement, transmitting user status being conferred on the user who has the token at any given time.

4. (canceled)

5. (canceled)

6. (canceled)

7. A content server as claimed in claim 3, wherein the processor comprises a notification module arranged to notify all users in the video conference who is designated as transmitting user.

8. A content server as claimed in claim 1, further comprising a data store arranged to store the received video, wherein the data store is arranged to store video contributions from each user and wherein the video contributions from each user in the video conference session are stored together as a single video file, the stored video file being stored as part of a video package, the video package additionally comprising a meta-data file.

9. (canceled)

10. (canceled)

11. (canceled)

12. A content server as claimed in claim 1, further comprising a data store for storing a plurality of content files wherein the file streaming module is arranged to stream one or more of the stored content files to a user terminal on request.

13. A content server as claimed in claim 12, wherein each time a content file is streamed to a user terminal the content server is additionally arranged to stream a third party content file, the third party content file being selected in dependence upon attribute information associated with the third party content file and a user profile associated with the user terminal to which the content file is being streamed.

14. A content server for distributing content to a first communications apparatus, the server comprising:
a data store for storing a plurality of content files;
a file streaming module arranged to stream one or more content files to the first communications apparatus
wherein the data store is arranged to store each content file as part of a content package, the content package comprising the content file and a meta-data file relating to the content file.

15. A server as claimed in claim 14, wherein the server is arranged to update the meta-data file each time a particular content file is streamed with details of the number of times a particular content file has been streamed and wherein the first communications apparatus is associated with a user and the server is arranged to update the meta-data file with details of the user who has requested the content file.

16. (canceled)

17. (canceled)

18. A server as claimed in claim 14, wherein the server is arranged to stream content files to a plurality of communications apparatus, each communications apparatus being associated with a user profile, each user profile comprising user-related content preferences and wherein the data store comprises content packages that have originated from one or more third parties, the meta-data file of each third party content package comprising attribute information associated with the corresponding content file within the third party content package and wherein, when a particular content file is streamed to the first communications apparatus, the server is arranged to additionally stream a third party content file, the third party content file being selected in dependence upon the attribute information associated with the third party content files and the user profile associated with the first communication apparatus and the third party content file being appended to the streamed content file.

19. (canceled)

20. (canceled)

21. (canceled)

22. A server as claimed in claim 14, wherein the content server is arranged to distribute content files between a plurality of communications apparatus and wherein, each time a content file is streamed to a communications apparatus, an associated meta-data file is updated.

23. A server as claimed in claim 22, wherein each time a content file is streamed to a communications apparatus the content server is arranged to additionally stream a third party content file, the third party content file being selected in dependence upon attribute information associated with the third party content file and user profiles associated with the plurality of communications apparatus.

24. A server as claimed in claim 14, further comprising inputs arranged to receive content files uploaded from a first communications apparatus for subsequent streaming to other communications apparatus.

25. A content server for distributing content to a communications apparatus, the server comprising:
a data store for storing content packages, each content package comprising one or more content files and a meta-data file, the meta-data file comprising attribute information associated with the one or more content files;
a file streaming module arranged to stream user-selected content files to the communications apparatus
wherein the communications apparatus is associated with a user profile, the user profile comprising user related content preferences and wherein, when a content file is selected and streamed to the communications apparatus, an additional content file is selected in dependence on the attribute information associated with the content files and the user profile associated with the communication apparatus, the additional content file being streamed to the communications apparatus in addition to the selected content file.

26. A content server as claimed in claim 25, wherein the additional content file is appended to the file stream after the user selected content file and the additional content file is loaded onto the content server by a broadcaster, the additional content file being an advert.

27. (canceled)

28. (canceled)

29. A content server as claimed in claim 14, wherein the communications apparatus is a networked computer or an internet enabled mobile communications device.

30. A content server as claimed in claim 1, wherein the user terminal is a networked computer or an internet enabled mobile communications device.

31. A content file comprising a two or more content portions and a meta-data file, the two or more content portions relating to content received from different sources.

32. A content file as claimed in claim 31, wherein the content is received from different communications devices belonging to different users of a content distribution system.
